(19) United States
(12) Patent Application Publication
(10) Pub. No.: US 2007/0117540 A1
(43) Pub. Date: May 24, 2007

(54) Electronic equipment for a wireless communication system and method for operating an electronic equipment for a wireless communication system

(76) Inventor: Thomas Jonsson Ekdahl, Sodra Sandby (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/286,959

(22) Filed: Nov. 23, 2005

(51) Int. Cl. H04L 12/58

(52) U.S. Cl. 455/412.1

(57) ABSTRACT

The present invention relates to an electronic equipment for a wireless communication system comprising a device operable to communicate within the wireless communication system for receiving an electronic program guide information via the wireless communication system, a device for outputting the received electronic program guide information to a user, a device operable to accept input for enabling the user to select content from the output electronic program guide information and for enabling the user to select an application and a central control unit for processing the selected content according to the selected application. The present invention further relates to a method for operating and electronic equipment for a wireless communication system, and to a program product directly loadable into the internal memory of an electronic equipment.

### TECHNICAL FIELD OF THE INVENTION

The present invention relates to an electronic equipment for a wireless communication system and to a method for operating an electronic equipment for a wireless communication system. Specifically, the present invention relates to the problem of integrating an electronic program guide system into an electronic equipment for a wireless communication system.

### DESCRIPTION OF RELATED ART

At present, electronic program guides (EPG), which is an application provided by media centres to list current and scheduled programs that are a will be available on each channel on TV, get more and more important.

Document JP2003-219 196 reveals the use of a mobile phone, which is able to download EPG information. The mobile phone is further able to transmit information via short distance radio communication to a television, a video recording and/or playing device or other electronic devices. After downloading the EPG information the user is able to select one ore more of the programs listed in the EPG and to thereby remotely control the TV set or video, that is the user is able to switch the channel on TV or to set a recording time for the video recorder by use of his mobile phone.

### SUMMARY

It is desirable to improve the prior art.

This is achieved, for example, by an electronic equipment for a wireless communication system according to claim 1

An aspect of the present invention relates to an electronic equipment for a wireless communication system comprising a device operable to communicate within the wireless communication system for receiving an electronic program guide information via the wireless communication system, a device for outputting the received electronic program guide information to a user, a device operable to accept input for enabling the user to select content from the output electronic program guide information and for enabling the user to select an application and a central control unit for processing the selected content according to the selected application.

This is further achieved, for example, by a method for operating an electronic equipment for a wireless communication system according to claim 10.

Another aspect of the present invention relates to a method for operating an electronic equipment for a wireless communication system, comprising the steps of receiving an electronic program guide information via the wireless communication system, outputting the received electronic program guide information to a user, enabling the user to select content from the output electronic program guide information and enabling the user to select an application and processing the selected content according to the selected application.

This is further achieved, for example, by a program product according to claim 18.

Another aspect of the present invention relates to a program product directly loadable into the internal memory of an electronic equipment, comprising software code portions for performing the steps of receiving an electronic program guide information via the wireless communication system, outputting the received electronic program guide information to a user, enabling the user to select content from the output electronic program guide information and enabling the user to select an application and processing the selected content according to the selected application, when said product is run on said electronic equipment.

In the context of the present application and the present invention, the term “electronic equipment for a wireless communication system” includes any kind of portable radio communication equipment. The term “portable radio communication equipment” includes all equipment such as mobile telephones, mobile cell phones, pagers, personal digital assistants, communicators, Al electronic organisers, smart phones or the like. The term “wireless communication system” relates to any kind of communication or telecommunication system which enables the wireless transfer of information, including e.g. cellular telecommunication systems, IrDA (infrared), Bluetooth and the like.

It should be emphasised that the term “comprises/comprising” when used in the specification is taken to specify the presence of stated features, integers, steps or components but does not preclude the presence or addition of one or more other features, integers, steps, components or groups thereof.

Preferably, for the reception of the electronic program guide information by the communication means an end to end protocol is provided.

According to one aspect the application is a messaging application.

The messaging application may be operable to send the selected electronic program guide information via SMS (short message service), MMS (multimedia message service) and/or e-mail. The transmission could be realised in the wireless communication system and/or in an IrDA, Bluetooth or any other suitable system.

According to another aspect the application is a calendar application.

The calendar application may be operable to add the selected electronic program guide information to the calendar of the electronic equipment for a wireless communication system and/or to create a reminder for the selected electronic program guide information.

Another to a further aspect the application is an entertainment application.

The entertainment application may be operable to create an image of the selected electronic program guide information.

The received electronic program guide information may be stored in a memory.

### BRIEF DESCRIPTION OF THE DRAWINGS

The present invention in the following will be explained in more detail with reference to the Figures in which

FIG. 1 shows a block diagram of an example of an electronic equipment according to the present invention,

FIG. 2 shows a block diagram of a system comprising an electronic equipment according to the present invention,

FIG. 3 shows an example of an electronic program guide,

FIG. 4 shows an embodiment of a menu function for selecting an electronic program guide content and

FIG. 5 shows an overview of the applications for processing the electronic program guide.

### DETAILED DESCRIPTION OF EMBODIMENT

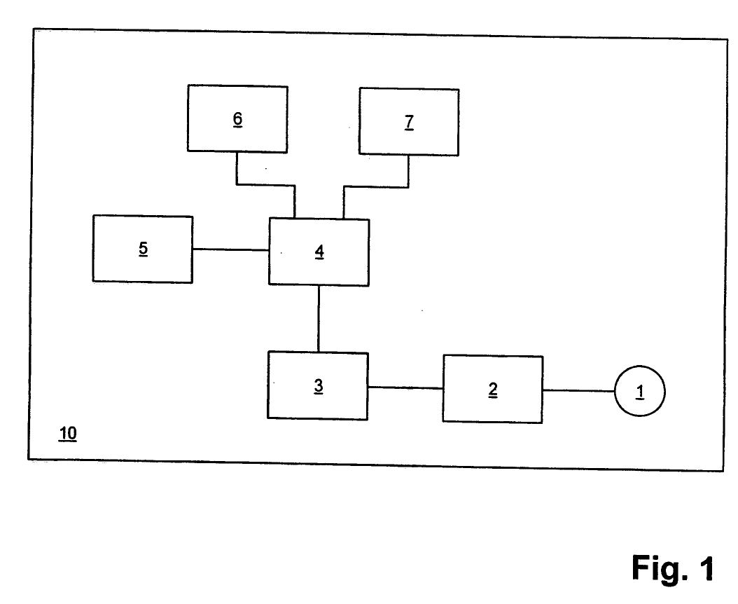

FIG. 1 shows a schematic block diagram of an electronic equipment 10 according to the present invention. The electronic equipment 10 is able to transmit and receive information in a wireless communication system, such as e.g. the UMTS, the GSM or any other available wireless telecommunication system.

For the transmission and reception of wireless signals in the telecommunication system, the electronic equipment 10 comprises an antenna 1 which is connected to a device for transmitting/receiving 2, which can e.g. be embodied as an high-frequency (HF) unit in case of a GSM or a UMTS system. The device for transmitting/receiving 2 is connected to further processing means, which are shown in FIG. 1 as a processing block 3. The processing block 3 comprises the further processing means necessary for (de)modulating, (de)coding and so forth a received or transmitted information signals depending on the wireless communication system in which the information signals are being transmitted and received. It is to be noted that the electronic equipment 10 in practice comprises all necessary means and units to be operated in the respective wireless communication system. For the sake of clarity, FIG. 1 and the present description only show and relate to the functionalities which are necessary to understand the present invention.

The processing block 3 is connected to a central control unit 4, which can e.g. be embodied in a micro processor, central processing unit or the like. The central control unit 4 controls the operation of the electronic equipment 10. A memory 5 is connected to the central control unit 4. The central control unit is further connected to an device for outputting 6 and an device operable to accept input 7. The device for outputting 6 may be, for example, a display, loudspeakers, an interface for wireless transmission or transmission via cable to a further device. As an example, the device for outputting 6 is e.g. a usual cell phone display in case that the electronic equipment is a portable cell phone. The device operable to accept input 7 is, for example, a keypad, touch pad, means for recognition of speech or an interface for the reception of data or information either wireless or via cable from any other device. For example, in case that the electronic equipment is a portable cell phone then the input means 7 corresponds to the usual input keys enabling a user to input numbers, characters and symbols.

The central control unit 4 is further connected to memory 5 for storing information and/or software code for the operation of the electronic equipment 10. Hereby, the memory 5 comprises an information source identification memory, a e.g. phone book memory for storing information source identification information, e.g. phone numbers, e-mail addresses and the like and additional information relating to the identity of the information sources, such as names, images and/or the like. The memory 5 further comprises software code for the operation of different applications of the electronic equipment 10. Appropriate software code can be prepared by a person who has ordinary skill in the art to carry out the functions and operation described herein.

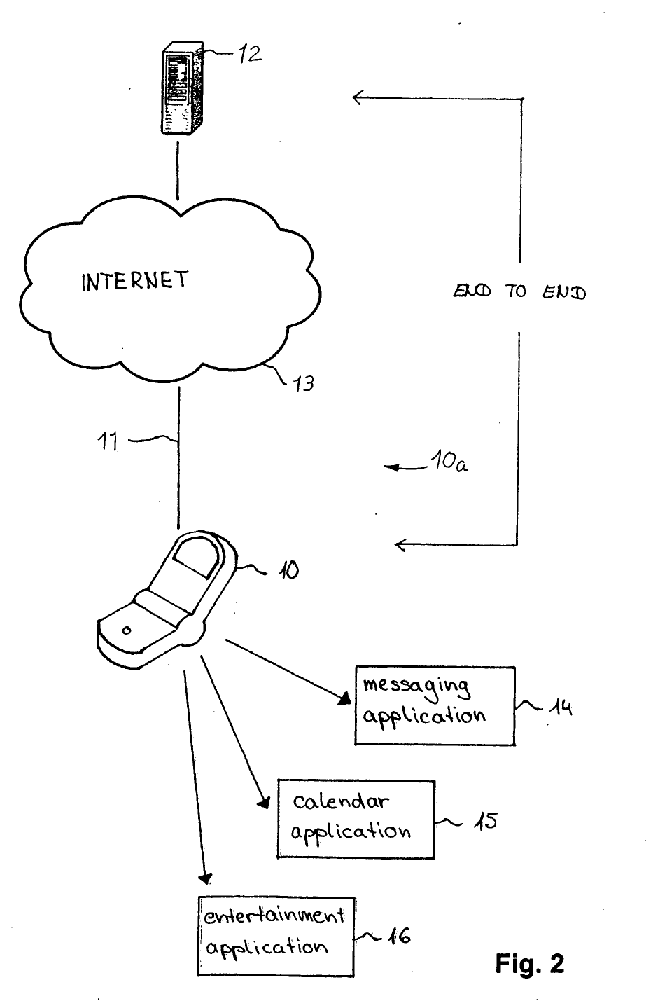

FIG. 2 shows an overview of the system comprising the electronic equipment 10 according to the present invention. The electronic equipment 10 via the device for transmitting/receiving and the antenna is able to transmit and receive information via the wireless communication system, which, for example, is generally shown in a schematic way. Through a wireless communication system 10a the electronic equipment 10 sets up a communication 11 to an EPG server 12 via the internet 13 ; or that communication may be set up entirely wirelessly with the EPG server 12, or using both wireless communication and wired internet communication, or using cable modem, satellite, and/or other communication devices and systems. The user can then select to download the actual electronic program guide information from the EPG server 12, e.g. by means of an end to end protocol, and to store it in the memory 5 of the electronic equipment 10. It is then possible for the user to select one or more contents of the EPG and to process the selected contents with one or more applications, e.g. a messaging application 14, a calendar application 15 or an entertainment application 16.

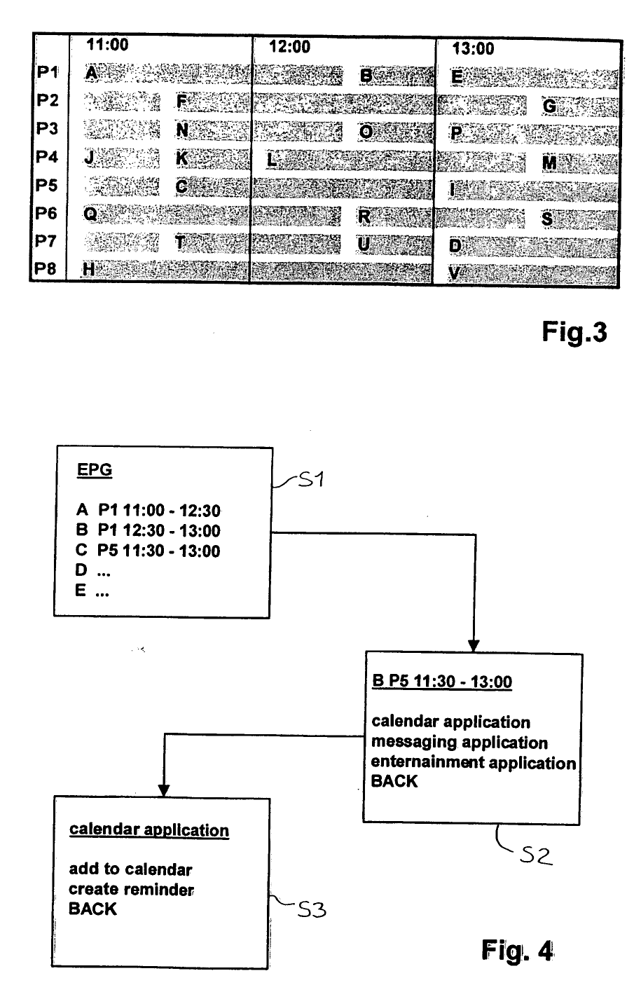

FIG. 3 shows an example of an electronic program guide information which is used with digital set-top boxes and newer television sets or media centres. The content in EPG is usually received from the internet and is commonly used in media centres e.g. Windows XP media centre edition. The standard for this is called XMLTV. In the EPG as shown in FIG. 3 in each line a different channel is listed as programs P1 to P8. Every column denotes a different time of the day, e.g. in FIG. 3 11 o'clock, 12 o'clock and 1 o'clock (13:00) are shown. In every line the name and duration of a specific program, that is a film, a soap opera, a quiz, a documentation or the like is shown. In addition, further information such as a short summary or the actors may be shown. The user can then select one or more of the programs in order to process the EPG content with further applications.

FIG. 4 shows an exemplary embodiment of possible menu functions for selecting and processing an EPG content with different applications. In the first step SI the different programs according to the downloaded EPG may be listed; alternatively the user may select one or more programs directly from the EPG as shown in FIG. 3. After selection of one or more programs in step S2 the user can select between different applications usable to further process the selected EPG content. According to the present invention there may be a calendar application, a messaging application or an entertainment application. After selection of one of these applications in step S3 the user can further decide in which way to process the selected EPG content with the selected application, e.g., as is illustrated in FIG. 4 at Step S3 the calendar application has been selected.

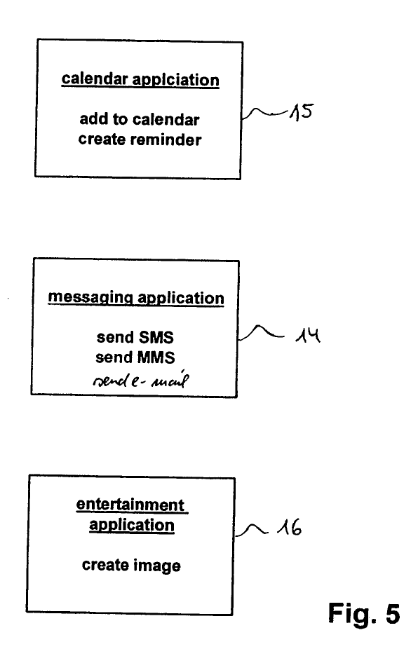

FIG. 5 shows an overview of the applications for processing the electronic program guide. A first possibility is processing the EPG content with a messaging application 14. After selecting an EPG content the user is able to send the selected EPG content to one or more further electronic equipments for example via SMS, MMS and/or e-mail. The transmission could take place in the wireless communication system and/or in an IrDA, Bluetooth or any other suitable communication system supported by the electronic equipment. Herefore, the user is able to select a name and corresponding address, e-mail, phone number or the like from the phone books stored in the memory 5 or to input directly phone number, e-mail address or the like via the device operable to accept input 7. Further the user may have the possibility to select between different options, e.g. if he wants only to send the title and time of the selected EPG content or if he wants to although send further information such as a summary, actors or the like.

A further possibility is to process the selected EPG content with a calendar application 15, which also is shown at Step S3 in FIG. 4. After selecting one or more contents from the EPG the user may be able to either add the selected EPG content to the calendar so that the date and time of the selected content is scheduled on the calendar or he may be able to create a reminder, so that he is reminded of the selected program. Hereby, for the reminder he can chose between different options, e.g. if he wants to be reminded one or more hours in advance or several days in advance.

According to a third possibility the user may process the selected EPG content with an entertainment application 16. Hereby, the user can store the EPG as shown in FIG. 3 as a picture in the memory 5 of the electronic equipment 10. He can then use the picture as background for the display of this electronic equipment or the picture may be separated into different areas and thereby used as a puzzle.

The present invention thereby includes and is described with respect to a wide range of applications and functionalities with reference to electronic program guide information downloaded on an electronic equipment 10.

Although the above generally describes the present invention according to specific exemplary processes and apparatus, various modification can be made without departing from the spirit and/or scope of the present invention. Therefore, the present invention should not be construed as being limited to the specific forms shown in the appended figures and as described above.

1. Electronic equipment for a wireless communication system comprising
a device operable to communicate within the wireless communication system for receiving an electronic program guide information via the wireless communication system,
a device for outputting the received electronic program guide information to a user,
a device operable to accept input for enabling the user to select content from the output electronic program guide information and for enabling the user to select an application and
a central control unit for processing the selected content according to the selected application.

2. Electronic equipment according to claim 1,
whereby for the reception of the electronic program guide information by the communication means an end to end protocol is provided.

3. Electronic equipment according to claim 1,
whereby the application is a messaging application.

4. Electronic equipment according to claim 3,
whereby the messaging application is operable to send the selected electronic program guide information via SMS, MMS and/or e-mail.

5. Electronic equipment according to claim 1,
whereby the application is a calendar application.

6. Electronic equipment according to claim 5,
whereby the calendar application is operable to add the selected electronic program guide information to the calendar and/or to create a reminder for the selected electronic program guide information.

7. Electronic equipment according to claim 1,
whereby the application is an entertainment application.

8. Electronic equipment according to claim 7,
whereby the entertainment application is operable to create an image of the selected electronic program guide information.

9. Electronic equipment according to claim 1,
whereby the received electronic program guide information is stored in a memory.

10. Method for operating an electronic equipment for a wireless communication system, comprising the steps of
receiving an electronic program guide information via the wireless communication system,
outputting the received electronic program guide information to a user,
enabling the user to select content from the output electronic program guide information and enabling the user to select an application and
processing the selected content according to the selected application.

11. Method according to claim 10,
whereby for the reception of the electronic program guide information by the communication means an end to end protocol is provided.

12. Method according to claim 10,
whereby the application is a messaging application.

13. Method according to claim 12,
whereby the messaging application is operable to send the selected electronic program guide information via SMS and/or MMS.

14. Method according to claim 10,
whereby the application is a calendar application.

15. Method according to claim 14,
whereby the calendar application is operable to add the selected electronic program guide information to the calendar and/or to create a reminder for the selected electronic program guide information.

16. Method according to claim 10,
whereby the application is an entertainment application.

17. Method according to claim 16,
whereby the entertainment application is operable to create an image of the selected electronic program guide information.

18. Method according to claim 10,
whereby the received electronic program guide information is stored in a memory.

19. A program product directly loadable into the internal memory of an electronic equipment, comprising software code portions for performing the steps of claim 10 when said product is run on said electronic equipment.
